(19) United States
(12) Patent Application Publication
(10) Pub. No.: US 2006/0124851 A1
(43) Pub. Date: Jun. 15, 2006

(54) Omnidirectional photodetector

(75) Inventor: Junichi Kajikuri, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/300,198

(22) Filed: Dec. 14, 2005

(30) Foreign Application Priority Data
Dec. 15, 2004 (JP) 2004-362330

(51) Int. Cl. G01J 5/00

(52) U.S. Cl. 250/338.1

(57) ABSTRACT

An omnidirectional photodetector has a prism and a light-detecting device. The prism has a cylindrical columnar body and a conical member disposed on an end of the columnar body and having a cross-sectional area that is progressively smaller toward a tip end of the conical member. The prism is made of a light-transmissive synthetic resin. When the omnidirectional photodetector is in use, the conical member is positioned above the columnar body and has its axis oriented vertically. The conical member has a conical surface as an outer circumferential surface thereof providing a reflecting surface for reflecting a light beam applied from an external source to the conical surface into the columnar body and downwardly toward the lower end of the columnar body.

### CROSS-REFERENCES TO RELATED APPLICATIONS

The present invention contains subject matter related to Japanese Patent Application JP 2004-362330 filed in the Japanese Patent Office on Dec. 15, 2004, the entire contents of which being incorporated herein by reference.

### BACKGROUND OF THE INVENTION

The present invention relates to an omnidirectional photodetector for use in an infrared radiation detector or the like for detecting an infrared signal that is transmitted from an infrared signal transmitter, for example.

There have been proposed omnidirectional photodetectors for use in infrared radiation detectors for detecting infrared signals that are transmitted from infrared signal transmitters or the like. The proposed omnidirectional photodetectors comprise a prism having an inverted conical recess defined in the upper surface of a columnar body and providing a reflecting surface for reflecting a light beam that is applied from a side surface of the prism, and a light-detecting device mounted on the lower end of the prism for detecting the light beam that is reflected by the reflecting surface. For details, reference should be made to Japanese Patent Laid-open No. Hei 5-175910 and Japanese Patent Publication No. Hei 5-175911.

If the distance between an omnidirectional photodetector and an infrared signal transmitter, which allows the level of a signal detected by the light-detecting device to have a minimum level that can be processed by a signal processor of the omnidirectional photodetector, is defined as a communicatable range, then the communicatable range should preferably be as large as possible to provide a wide range in which the infrared signal transmitter can be used.

Though the conventional omnidirectional photodetectors referred to above have a certain communicatable range, their communicatable range still needs to be improved.

### SUMMARY OF THE INVENTION

The present invention has been made in view of the above circumstances and provides an omnidirectional photodetector which is constructed for a desired communicatable range.

In order to attain the desire described above, there is provided in accordance with the present invention an omnidirectional photodetector including a prism having a columnar body and a conical member disposed on an end of the columnar body and having a cross-sectional area that is progressively smaller toward a tip end of the conical member, the conical member having a conical surface as an outer circumferential surface thereof providing a reflecting surface for reflecting a light beam applied from an external source to the conical surface into the columnar body, and a light-detecting device disposed at an opposite end of the columnar body, for detecting the light beam reflected by the reflecting surface and guided through the columnar body.

With above arrangement, the conical surface of the conical member of the prism provides a reflecting surface for reflecting a light beam applied from an external source to the conical surface into the columnar body. Therefore, the light beam applied to the conical surface is guided to the light-detecting device disposed at the opposite end of the columnar body. The omnidirectional photodetector is thus effective to keep a desired communicatable range for a device which applies the light beam to the omnidirectional photodetector.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a block diagram of an infrared remote controller including an infrared transmitter and an infrared receiver;

FIG. 2A is a plan view of the infrared receiver;

FIG. 2B is a view taken in the direction indicated by the arrow B in FIG. 2A;

FIG. 2C is a view taken in the direction indicated by the arrow C in FIG. 2A;

FIG. 3D is a view taken in the direction indicated by the arrow D in FIG. 2A;

FIG. 3E is a cross-sectional view taken along line E-E of FIG. 2B;

FIG. 3F is a cross-sectional view taken along line F-F of FIG. 2A;

FIG. 4 is a perspective view of the infrared receiver;

FIG. 5 is a perspective view of a personal computer with the infrared receiver mounted thereon;

FIG. 6 is an enlarged fragmentary perspective view of the infrared receiver mounted on the personal computer shown in FIG. 5;

FIGS. 7A through 7D are views illustrative of the manner in which light beams are applied to a prism;

FIGS. 8A through 8D are views illustrative of the manner in which light beams are applied to the prism; and

FIG. 9 is a diagram showing measured values of the communicatable range of the infrared detector.

### DETAILED DESCRIPTION

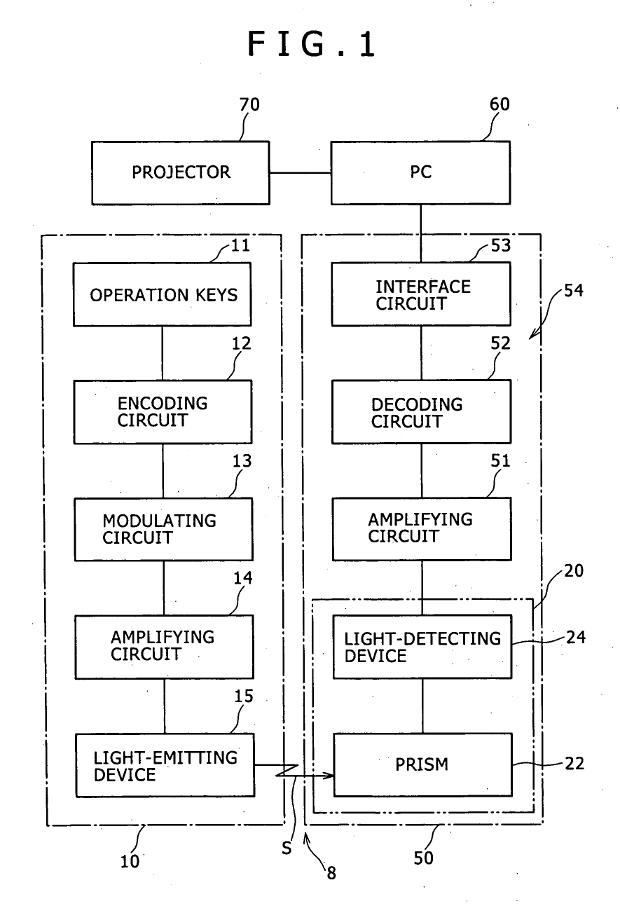

As shown in FIG. 1, an infrared remote controller 8 includes an infrared transmitter 10 and an infrared receiver 50. The infrared receiver 50 incorporates an omnidirectional photodetector 20 according to the present invention.

The infrared receiver 50 is connected to a personal computer 60 through an interface such as a USB (Universal Serial Bus) for communication with the personal computer 60.

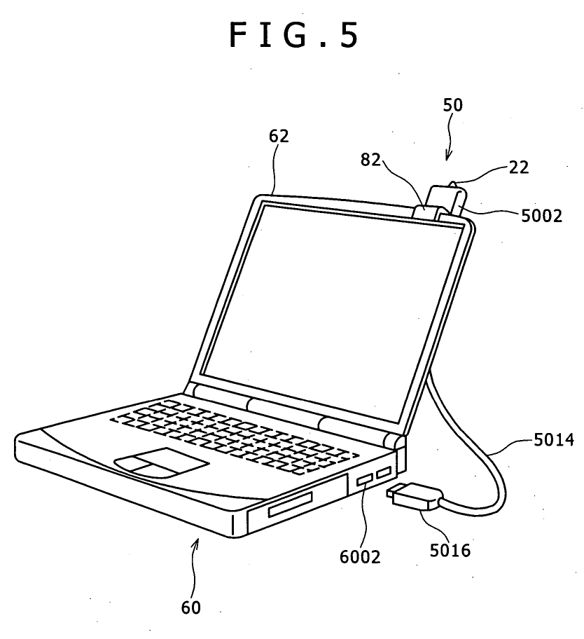

The personal computer 60 has a display panel 62 (see FIG. 5). When the personal computer 60 operates based on an application program installed therein, it displays images including characters and still and moving images on the display panel 62.

The personal computer 60 supplies a video signal representing images to be displayed on the display panel 62 to a projector 70.

The projector 70 includes a liquid-crystal display device for forming an image based on the video signal supplied from the personal computer 60, a light source for emitting light to the liquid-crystal display device, which emits light modulated by the image formed thereby, and an optical system for focusing the light emitted by the liquid-crystal display device onto a screen, not shown.

The infrared transmitter 10 includes a plurality of operation keys 11 assigned to control data to be given to the personal computer 60, an encoding circuit 12 for generating a data code represented as binary data (expressed by a combination of Os and is) by encoding the control data output from the operation keys 11, a modulating circuit 13 for modulating a carrier signal with the data code, an amplifying circuit 14 for amplifying a modulated signal from the modulating circuit 13 and outputting the amplified signal as a drive signal, and a light-detecting device 15 for outputting an infrared signal S as a light beam based on the drive signal supplied from the amplifying circuit 14.

The infrared receiver 50 has the omnidirectional photodetector 20 and a signal processor 54.

The omnidirectional photodetector 20 serves to detect the infrared signal S output as a light beam from the light-detecting device 15, and output a detected signal.

The signal processor 54 includes an amplifying circuit 51, a decoding circuit 52, and an interface circuit 53.

The amplifying circuit 51 amplifies the detected signal output from the omnidirectional photodetector 20.

The decoding circuit 52 demodulates the amplified detected signal from the amplifying circuit 51 back into the data code, decodes the data code, and outputs the decoded data code as the control data.

The interface circuit 53 converts the control data supplied from the decoding circuit 52 into USB data, and supplies the USB data to the personal computer 60.

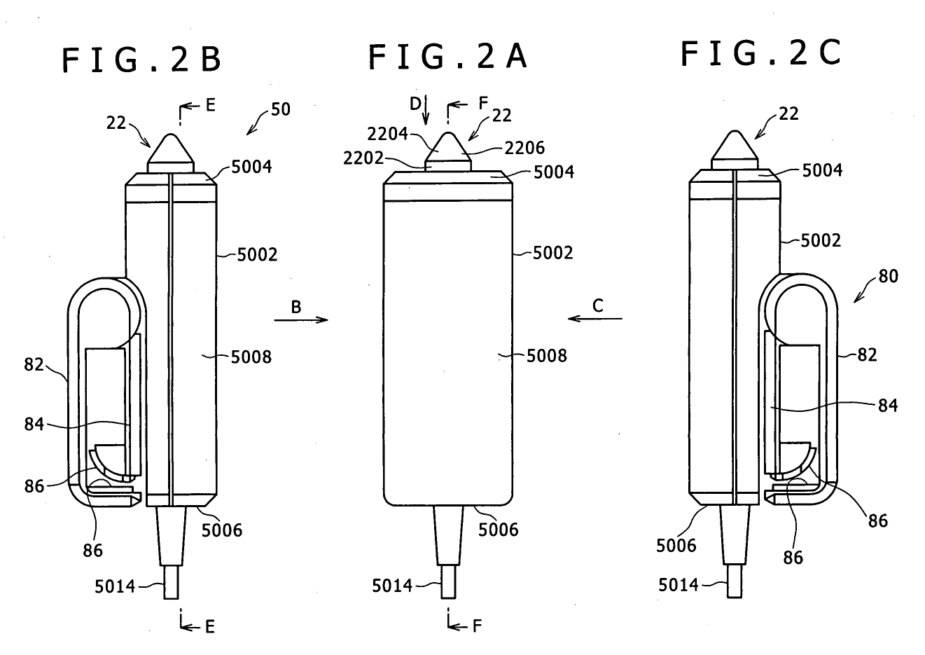

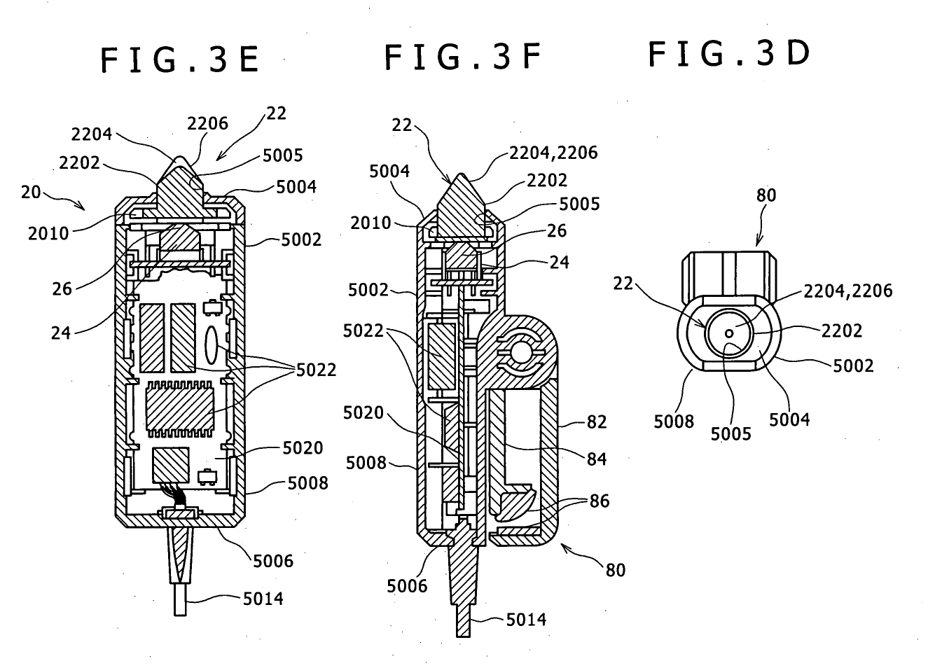

As shown in FIGS. 2A through 2C and 3D through 3F, the infrared receiver 50 includes a casing 5002 having a vertical height, a horizontal width smaller than the vertical height, and a thickness or depth smaller than the horizontal width.

The casing 5002 has an upper end wall 5004 disposed on an upper end thereof, a lower end wall 5006 disposed on a lower end thereof, and a side wall 5008 interconnecting peripheral edges of the upper end wall 5004 and the lower end wall 5006.

The omnidirectional photodetector 20 is disposed in an upper portion of the casing 5002. The omnidirectional photodetector 20 has a prism 22 and a light-detecting device 24.

The prism 22 includes a cylindrical columnar body 2202 and a conical member 2204 disposed on an upper end of the columnar body 2202 and having a cross-sectional area that is progressively smaller toward the tip end of the conical member 2204. According to the present embodiment, the prism 22 is made of light-transmissive synthetic resin such as acrylic resin, for example.

The columnar body 2202 has a lower portion inserted in an opening 5005 defined in the upper end wall 5004 of the casing 5002. With the columnar body 2202 thus positioned, the conical member 2204 is located above the columnar body 2202 and has its axis extending vertically, and the conical member 2204 is exposed in its entirety and the columnar body 2202 is exposed partly.

The conical member 2204 has a conical surface 2206 as its outer circumferential surface providing a reflecting surface for reflecting a light beam applied from an external source to the conical surface 2206 into the columnar body 2202 and downwardly toward the lower end of the columnar body 2202.

In the present embodiment, the columnar body 2202 has a diameter of 9 mm, and the conical member 2204 has an apex angle of about 70 degrees. The conical member 2204 has a round tip end having a radius of about 1 mm. If the radius of the round tip end is too large, then it is difficult for the conical surface 2206 to have a required surface area. If the radius of the round tip end is too small, then it is difficult to shape the columnar body 2202 as desired. For these reasons, the radius of the round tip end should preferably be about 1 mm. Since the round tip end of the conical member 2204 is resistant to damage, it is effective to prevent the conical member 2204 from being damaged.

The prism 22 also has a rectangular plate 2010 disposed on the lower end of the columnar body 2202 remote from the conical member 2204. The rectangular plate 2010 extends in a direction perpendicularly to the axis of the conical member 2204 and has a profile, as viewed in plan, greater than the profile of the columnar body 2202.

The light-detecting device 24 is disposed beneath the lower end of the columnar body 2202, i.e., in the upper portion of the casing 5002 in axial alignment with the conical member 2204. The light-detecting device 24 detects the light beam applied to the conical surface 2206 and guided through the columnar body 2202 to the light-detecting device 24, generates a detected signal based on the detected light beam, and supplies the detected signal to the amplifying circuit 51.

A condenser lens 26 for converging the light beam emitted from the plate 2010 on the lower end of the columnar body 2202 onto the light-detecting device 24 is disposed between the plate 2010 and the light-detecting device 24. In the present embodiment, the condenser lens 26 is integrally combined with the light-detecting device 24.

The casing 5002 also houses therein an elongate rectangular printed-circuit board 5020 with its longer sides oriented vertically and its shorter sides horizontally.

On the printed-circuit board 5020, there are mounted electronic components 5022 including ICs, capacitors, quartz crystal oscillators, etc. which make up the amplifying circuit 51, the decoding circuit 52, and the interface circuit 53.

A connecting cable 5014 has an end connected to a lower portion of the printed-circuit board 5020, and extends out of the casing 5002 through an opening defined the lower end wall 5006 of the casing 5002. As shown in FIG. 5, a USB plug 5016 is connected to the other end of the connecting cable 5014 for connection to a USB connector 6002 of the personal computer 60.

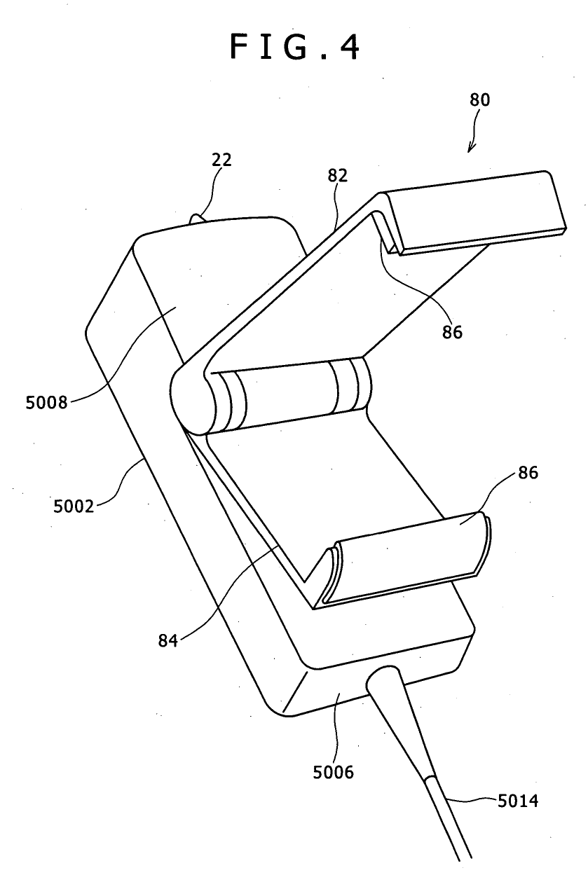

As shown in FIGS. 4, 5, and 6, an attachment 80 is disposed on the side wall 5008 of the casing 5002 for removably mounting the infrared receiver 50 on a thin-walled portion, such as the display panel 62 or the like, of the personal computer 60.

The attachment 80 has a first arm 82 and a second arm 84 that are pivotally coupled to the casing 5002 so as to be angularly movable toward and away from each other, and a biasing member (not shown) for normally biasing the first arm 82 and the second arm 84 to move toward each other.

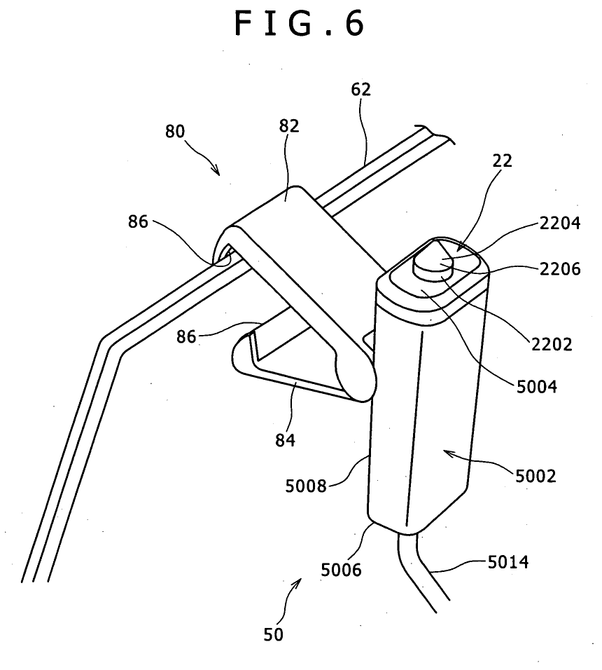

Grip layers 86 made of a material having a large coefficient of friction, such as rubber of the like, are mounted on respective distal ends of the first arm 82 and the second arm 84. When the infrared receiver 50 is mounted on the display panel 62 as shown in FIG. 6, the grip layers 86 on the first arm 82 and the second arm 84 frictionally engage the display panel 62 to keep the infrared receiver 50 on the display panel 62.

In use, the omnidirectional photodetector 20 operates as follows:

As shown in FIGS. 5 and 6, the infrared receiver 50 is mounted on the display unit 62 of the personal computer 60 by the attachment 80. The conical member 2204 is positioned above the display panel 62 and has its axis directed vertically.

When the operation keys 11 (see FIG. 1) of the infrared transmitter 10 are operated, the light-emitting device 15 outputs an infrared signal S as a light beam corresponding to the control data output from the operation keys 11.

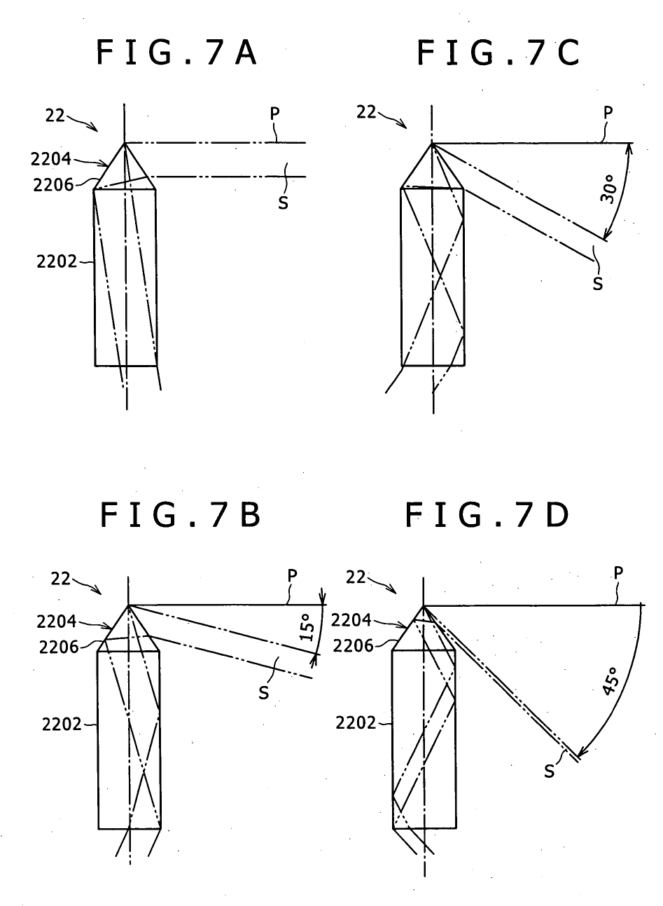

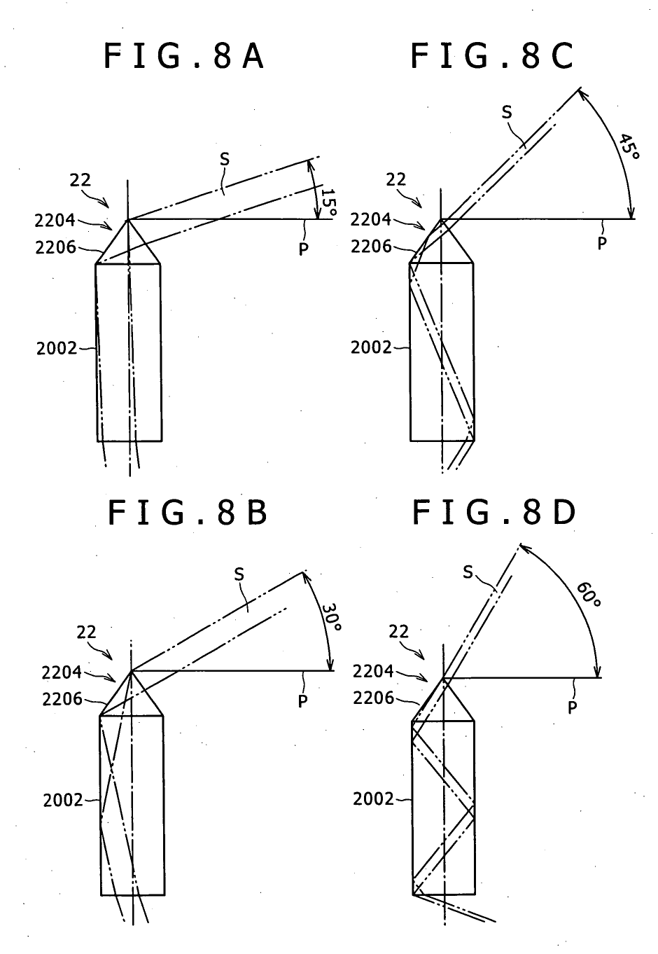

Of the light beam emitted as the infrared signal S, a light beam applied to the conical surface 2206 of the prism 22 of the omnidirectional photodetector 20 passes through one of paths shown in FIGS. 7A through 7D and FIGS. 8A through 8D, and is emitted from the lower end of the columnar body 2202. The emitted light beam is converged by the condenser lens 26 onto the light-detecting device 24.

The light-detecting device 24 detects the light beam, generates a detected signal based on the detected light beam, and supplies the detected signal to the amplifying circuit 51. The detected signal is amplified by the amplifying circuit 51 and then decoded by the decoding circuit 52 into the control data. The control data from the decoding circuit 52 is supplied through the interface circuit 53 to the personal computer 60.

The personal computer 60 performs a control process corresponding to the control data supplied thereto.

For example, if the personal computer 60 is executing an application program for displaying various images and characters in a slide show mode, then control processes that may be performed by the personal computer 60 include a process of switching between images (page scrolling), a process of lowering screen brightness (blackout), etc.

FIGS. 7A, 7B, 7C, and 7D show paths of light beams in the prism 22 when the angles e formed between the light beams representing the infrared signal S emitted from the infrared transmitter 10 to the conical member 2204 and a hypothetical plane P lying perpendicularly to the axis of the conical member 2204 are 0, 15, 30, and 45 degrees, respectively, downwardly of or clockwise from the hypothetical plane P.

FIGS. 8A, 8B, 8C, and 8D show paths of light beams in the prism 22 when the angles θ formed between the light beams representing the infrared signal S emitted from the infrared transmitter 10 to the conical member 2204 and the hypothetical plane P lying perpendicularly to the axis of the conical member 2204 are 15, 30, 45, and 60 degrees, respectively, upwardly of or counterclockwise from the hypothetical plane P.

It is assumed that the angle θ between the light beam representing the infrared signal S and the hypothetical plane P is positive if the light beam is tilted downwardly as it approaches the prism 22, and negative if the light beam is tilted upwardly as it approaches the prism 22.

As shown in FIGS. 7A through 7D and FIGS. 8A through 8D, the light beam reflected by the conical surface 2206 into the columnar body 2202 is guided by the columnar body 2202 toward the lower end thereof, from which the light beam is emitted downwardly.

The light beam that is emitted from the lower end of the columnar body 2202 spreads differently depending on the angle θ between the light beam and the hypothetical plane P.

Measurements made by the inventor have indicated that the light beam emitted from the lower end of the columnar body 2202 spreads minimally when the angle θ is 0 and 90 degrees, and spreads progressively greater as the angle θ increases from 0 degree to 90 degrees.

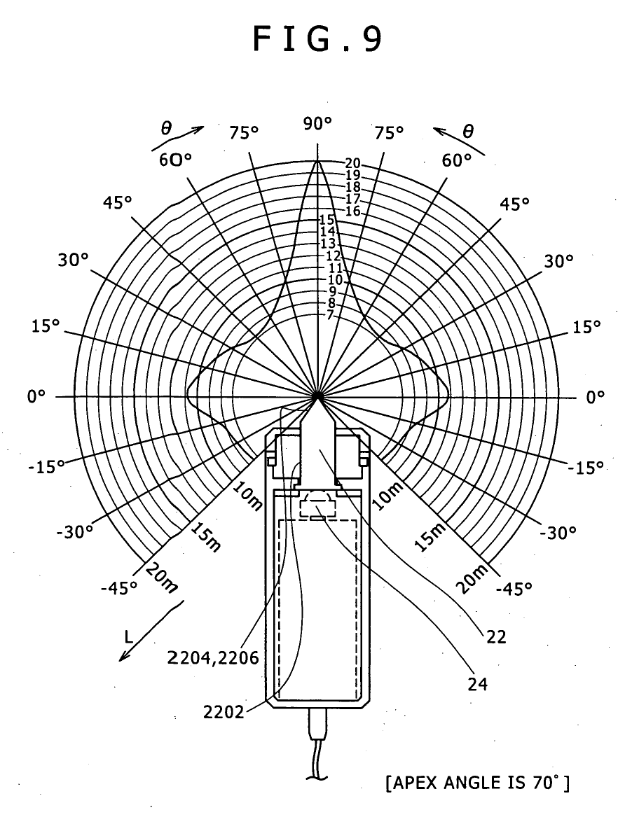

FIG. 9 is a diagram showing the relationship between the angle θ between the light beam and the hypothetical plane P and a communicatable range L when the apex angle of the conical member 2204 is 70 degrees.

The communicatable range L represents a distance between the omnidirectional photodetector 20 and the infrared transmitter 10, which allows the level of a signal detected by the light-detecting device 24 to have a minimum level that can be processed by the signal processor 54.

Regardless of the angle θ between the light beam and the hypothetical plane P, the communicatable range L should preferably be as large as possible to provide a wide range in which the infrared transmitter 10 can be used.

As shown in FIG. 9, the communicatable range L is of local maximum values when the angle θ is 0 and 90 degrees, and is progressively smaller as the angle θ increases from 0 degree to 90 degrees.

The inventor measured the communicatable range L with respect to different apex angles of the conical member 2204. As a result, it was found that the lowest value of the communicatable range L was highest when the apex angle of the conical member 2204 was about 70 degrees. Therefore, the apex angle of the conical member 2204 should preferably be about 70 degrees.

Specifically, as shown in FIG. 9, when the apex angle of the conical member 2204 is 70 degrees, the communicatable range L keeps a lowest value of 7 m regardless of changes in the angle θ between the light beam and the hypothetical plane P. This lowest value of the communicatable range L is higher than the lowest value of the communicatable range of the conventional omnidirectional photodetector described above.

The reasons for the higher lowest value of the communicatable range L are as follows:

The prism of the conventional omnidirectional photodetector has an inverted conical recess defined in the upper surface of a columnar body and providing a reflecting surface for reflecting a light beam that is applied from a side surface of the prism. Therefore, the columnar body has a ridge fully around the outer circumferential edge of the upper surface thereof, i.e., along the boundary between the surface of the inverted conical recess and the side surface of the columnar body. When the light beam is applied to the ridge, the light beam is spread thereby, and cannot efficiently be guided to the light-detecting device.

According to the present embodiment, however, since no ridge is present on the conical member 2204 of the prism 22, the light is not spread by the conical member 2204 and hence can efficiently be guided to the light-detecting device 24.

According to the present invention, the conical surface 2206 of the conical member 2204 provides a reflecting surface for reflecting a light beam applied from an external source to the conical surface 2206 into the columnar body 2202. Therefore, the light beam is efficiently guided to the light-detecting device 24 beneath the lower end of the columnar body 2202. The above arrangement according to the present invention is effective to keep a communicatable range for the infrared transmitter 10 which emits the infrared signal S to the omnidirectional photodetector 50.

If the apex angle of the conical member 2204 is 70 degrees, then the communicatable range L can have a large lowest value regardless of changes in the angle 0 formed between the light beam applied to the conical member 2204 and the hypothetical plane P lying perpendicularly to the axis of the conical member 2204. This arrangement is more effective to keep a communicatable range for the infrared transmitter 10 which emits the infrared signal S to the omnidirectional photodetector 50.

In the illustrated embodiment, the prism 22 is made of a light-transmissive synthetic resin such as acrylic resin. However, the prism 22 may be made of any of various other light-transmissive materials such as glass.

In the illustrated embodiment, the infrared receiver 50 is mounted on the display unit 62 of the personal computer 60. However, the infrared receiver 50 may be placed anywhere, e.g., on a desk.

Although a certain preferred embodiment of the present invention has been shown and described in detail, it should be understood that various changes and modifications may be made therein without departing from the scope of the appended claims.

1. An omnidirectional photodetector comprising:
a prism having a columnar body and a conical member disposed on an end of said columnar body and having a cross-sectional area that is progressively smaller toward a tip end of said conical member, said conical member having a conical surface as an outer circumferential surface thereof providing a reflecting surface for reflecting a light beam applied from an external source to said conical surface into said columnar body; and
a light-detecting device disposed at an opposite end of said columnar body, for detecting the light beam reflected by said reflecting surface and guided through said columnar body.

2. The omnidirectional photodetector according to claim 1, further comprising:
a condenser lens disposed between said opposite end of said columnar body and said light-detecting device.

3. The omnidirectional photodetector according to claim 1, wherein said conical member has a round tip end.

4. The omnidirectional photodetector according to claim 1, wherein said conical member has an apex angle of about 70 degrees.

5. The omnidirectional photodetector according to claim 1, wherein said prism is made of a light-transmissive synthetic resin.

6. The omnidirectional photodetector according to claim 5, wherein said light-transmissive synthetic resin is acrylic resin.

7. An infrared receiver for receiving an infrared radiation beam representing a signal which is modulated with encoded control data, comprising:
a prism having a columnar body and a conical member disposed on an end of said columnar body and having a cross-sectional area that is progressively smaller toward a tip end of said conical member, said conical member having a conical surface as an outer circumferential surface thereof providing a reflecting surface for reflecting an infrared radiation beam applied from an external source to said conical surface into said columnar body;
a light-detecting device disposed at an opposite end of said columnar body, for detecting the infrared radiation beam reflected by said reflecting surface and outputting a signal represented by said infrared radiation beam;
amplifying means for amplifying the signal output from said light-detecting device; and
decoding means for demodulating and decoding the detected signal amplified by said amplifying means, into control data, and outputting the control data.

8. The infrared receiver according to claim 7, further comprising:
interface means for converting the control data output from said decoding means into USB data and outputting said USB data.

9. The infrared receiver according to claim 8, for being connected to a computer through said interface means, wherein said control data comprises control data for controlling an application program installed in said computer.

10. The infrared receiver according to claim 9, wherein said application program comprises a program for displaying images on a display unit of said computer by switching between pages in a slide show mode, and said control data comprises control data for enabling said computer to scroll the images displayed on said display unit page by page and/or to display the images in uniform black or uniform white on said display unit.

11. The infrared receiver according to claim 7, further comprising:
a casing housing said prism and said light-detecting device therein with said conical member being exposed; and
attachment means mounted on said casing for disengageably engaging a plate-like member;
said attachment means comprising:
a first arm and a second arm which are pivotally coupled to said casing so as to be angularly movable toward and away from each other; and
biasing means for normally biasing said first arm and said second arm to move toward each other;
wherein said first arm and said second arm grip said plate-like member when said first arm and said second arm are angularly moved toward each other.
